(19) United States
(12) Patent Application Publication
(10) Pub. No.: US 2013/0121240 A1
(43) Pub. Date: May 16, 2013

(54) Delay Management in Shared Baseband Deployments

(71) Applicants: Jaroslaw Przada, Stittsville (CA); Glen Rempel, Kanata (CA)

(72) Inventors: Jaroslaw Przada, Stittsville (CA); Glen Rempel, Kanata (CA)

(73) Assignee: TELEFONAKTIEBOLAGET L M ERICSSON (PUBL), Stockholm (SE)

(21) Appl. No.: 13/297,326

(22) Filed: Nov. 16, 2011

(51) Int. Cl. H04W 4/00

(52) U.S. Cl. 370/328

(57) ABSTRACT

A method of controlling radio link delay in a multi-standard wireless system having a first Radio Equipment Controller (REC) operating with a first radio standard interface and a second REC operating with a second radio standard interface is disclosed. A time delay between the first REC and a Radio Equipment (RE) and a time delay between the second REC and the RE is determined. When radio signal data from the first and second REC are received, they are stored into a memory. The stored radio signal data is then marked in accordance with the calculated time delay. The marked radio signal data from each REC is then multiplexed into a single radio signal timed according to a reference timing clock signal for transmission to the RE.

### FIELD OF THE INVENTION

The present application relates generally to delay management in a base station and, more specifically, to managing alignment of radio frames operating on separate standards.

### BACKGROUND OF THE INVENTION

Network operators upgrading their networks from GSM or CDMA networks to LTE networks, want a network evolution solution which permit the leveraging of a portion of their installed baseband equipment. In some cases this means that multi-standard mixed mode radios are used to support efficient in-band combining to ease the service transition from GSM or CDMA equipment to LTE equipment. Emerging deployments of shared radio solutions for base stations operating on multiple standards face particular challenges in relation to operating multi-standard digital units and a shared radio unit.

In a typical wireless radio system, a Radio Equipment Controller (REC) sends and receives data from a remote Radio Equipment (RE) using a communication link, typically a serial one. Since modern radio standards typically require on-air timing synchronized to a universal time base, the wireless radio system must compensate for the delay created by the radio link and the radio.

In situations where a multi-standard wireless systems is used, non-homogeneous systems, ie. Systems that operate on different timing standards, are required to send and receive data from the same RE. In such situations, a multiplexing subsystem is required to multiplex data for use by the multi-standard equipment. The delay of the links may vary, as well as the interface standard of the link.

Each standard usually run standard specific buffers and delay logic for each carrier standard, thus making delay alignment much more difficult in a multi-standard wireless system.

For these reasons, traditional delay alignment methods have limited capabilities in situations as described above.

### SUMMARY OF THE INVENTION

The present invention is directed to alleviating the problems of the prior art.

The present invention overcomes the problems of the prior art by providing a method of controlling the delay of data on a radio link between a radio equipment controller and a remote equipment without resorting to standard-specific timing information imbedded in the link. This eliminates the need for having individual Radio Equipment Controllers (REC) from knowing the details of the multiplexing interface and radio equipment. As a result, non-homogenous REC interfaces can be seamlessly merged.

In accordance with a first embodiment of the present invention, there is provided a method of controlling radio link delay in a multi-standard wireless system having a first Radio Equipment Controller (REC) operating with a first radio standard interface and a second REC operating with a second radio standard interface. With this embodiment, a time delay between the first REC and a Radio Equipment (RE) and a time delay between the second REC and the RE is determined. When radio signal data from the first and second REC are received, they are stored into a memory. The stored radio signal data is then marked in accordance with the calculated time delay. The marked radio signal data from each REC is then multiplexed into a single radio signal timed according to a reference timing clock signal for transmission to the RE.

In accordance with another embodiment of the present invention, there is provided an interface unit for controlling radio link delay in a multi-standard wireless system having a first Radio Equipment Controller (REC) operating with a first radio standard interface and a second REC operating with a second radio standard interface. The interface is comprised of a timing source reference for providing a reference timing clock signal, a first timing signal buffer for determining a first time delay between the first REC and the Radio Equipment (RE) and a second timing signal buffer for determining a second time delay between the second REC and the RE. A memory is provided for storing received radio signal data from the first and second REC. A time stamp marker is provided for marking the stored radio signal data in accordance with a time delay calculated by the first and second timing signal buffers. A multiplexer is provided for multiplexing the marked radio signal data into a single radio signal timed according to the reference timing clock signal for transmission to the RE.

Other aspects and features of the present invention will become apparent upon review of the following description of specific embodiments of the invention in conjunction with the accompanying figures.

### BRIEF DESCRIPTION OF THE DRAWINGS

FIG. 1 is a block diagram illustrating the timing delay principles of a wireless system;

FIG. 2 is a block diagram illustrating the timing delay principles of a multi-standard wireless system according to an embodiment of the present invention; and

FIG. 3 is a block diagram of the multiplexing functional block used to describe the principles of the timing delay management according to the present invention; and

FIG. 4 is a block diagram of the multiplexing functional block showing the uplink side of the timing delay management system of the present invention.

### DETAILED DESCRIPTION OF THE EMBODIMENTS

In order to lighten the following description, the following acronyms will be used:
1PPS One Pulse per second
BTS Base Station
GPS Global Positioning System
MFB Multiplexing Functional Block
MUX Multiplexer
PHY Physical layer of the Open Systems Interconnection model of communication systems
RE Radio Equipment
REC Radio Equipment Controller

As indicated above, the present invention addresses the issues brought out by the aforementioned prior art.

With reference to FIG. 1, we have shown a block diagram of the timing delay principles of a wireless system. A radio equipment controller (REC) 100 communicates over a link 101 to a radio equipment (RE) 102. In operation, the REC 100 sends and receives data from the RE 102 using a communication link 101. Communication link 101 is typically defined as a serial link. As indicated previously, since modern radio standards typically require on-air timing synchronized to a universal time base, the system must compensate for the delay 103, created by the radio link 101 and the radio 102.

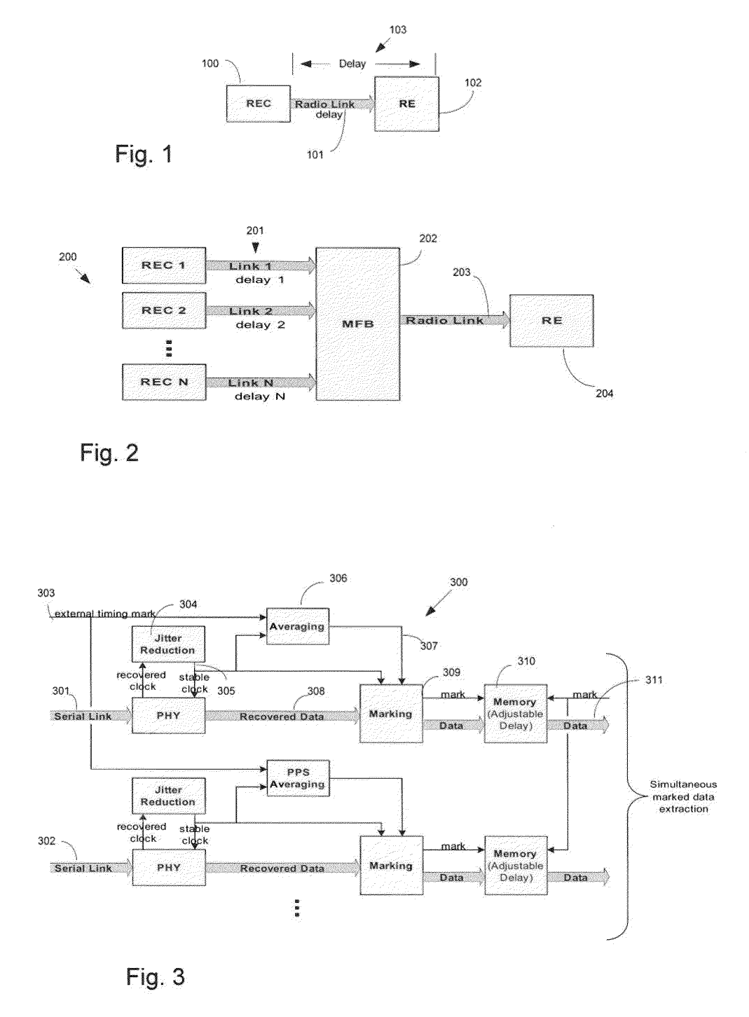

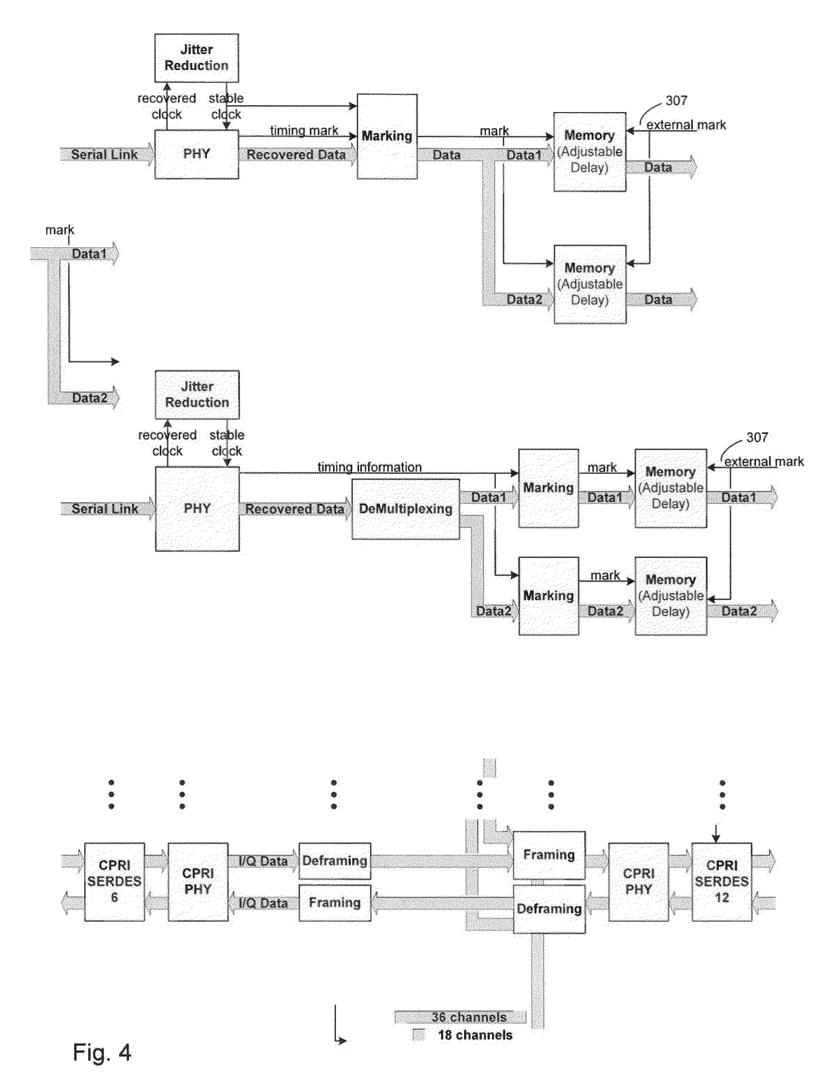

In situations where several non-homogeneous systems or multi-standard RECs are required to send and receive from the same RE, a sub-system to multiplex the data will be required. Such a scenario is shown in FIG. 2. In FIG. 2, a number of RECs (REC 1, REC 2, . . . REC n) 200 form a multi-standard wireless system. REC 1, for example could operate under a 2 G or 3 G standard (such as CDMA, GSM, etc.), whereas REC 2 operates a 4 G standard, such as LTE. Each REC 200 has a radio link 201 which creates a certain amount of delay. However, the delay created can vary according to the standard used by the REC 200. As will be illustrated further below, the purpose of the multiplexing functional block (MFB) 203 is to multiplex the radio link data of each REC link while controlling the delay of the data on each link without resorting to standard-specific timing information imbedded in the link. This way, data sent on radio link 204 from the MFB 203 to the RE 205 is synchronized and compensated for any time delay caused by a specific REC link delay 201.

FIG. 3 is a block diagram representing the MFB 300 (202 in FIG. 2). In this representation of the MFB 300, only two serial links 301 and 302 are shown to limit the complexity of the diagram. Serial links 301 and 302 are connected to their respective RECs (not shown) which may operate on different radio standard configurations as indicated above. The MFB is provided with an external PPS timing source 303, such as would be provided by a GPS receiver. Each serial link signal is processed for clock jitter reduction 304 and recovered. A stable clock 305 is regenerated from one of the radio links. The stable clock 305 is used to provide a time base to average 306 the position of the time synchronization signal 307. This provides a regular timing signal synchronized to the stable clock 305 and in-line with the synchronization reference input or timing source 303.

The radio data 308 recovered from the serial link 301. Samples of the radio data 308 corresponding to the timing signal are marked 309 and then stored into memory 310. The collected samples are put into memory 310 in sequential order. Memory 310 is used to adjust the radio signal samples according to the calculated delay for that serial link 301. In effect, the radio data samples are advanced such that they appear at the MFB interface early by the delay amount.

The marked radio samples at the output of each memory 310 are extracted at the same time but subsequent samples follow sequentially to line up for multiplexing into a single radio link (203 in FIG. 2). The marked samples are put into the radio link to appear at the correct time on air, either by putting them in at the correct time with respect to time reference or by indicating, using baseband markers in the radio link protocol.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, e.g., a router, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Thus, one embodiment is a computer readable medium containing computer readable instruction that, when executed by a processor, cause the processor to perform functions for maintaining clock synchronization between a first and a second radio.

In addition, unless mention was made above to the contrary, it should be noted that all of the accompanying drawings are not to scale. It will be appreciated by persons skilled in the art that the present invention is not limited to what has been particularly shown and described herein above. A variety of modifications and variations are possible in light of the above teachings without departing from the scope and spirit of the invention, which is limited only by the following claims.

We claim:

1. A method of controlling radio link delay in a multi-standard wireless system having a first Radio Equipment Controller (REC) operating with a first radio standard interface and a second REC operating with a second radio standard interface, comprising the steps of:
a) determining a first time delay between said first REC and a Radio Equipment (RE);
b) determining a second time delay between said second REC and said RE;
c) providing a reference timing clock signal;
d) receiving radio signal data from said first and second REC;
e) storing said received radio signal data into a memory;
f) marking said stored radio signal data in accordance with a time delay calculated in step a) and b); and
g) multiplexing said marked radio signal data into a single radio signal timed according to said reference timing clock signal for transmission to said RE.

2. An interface unit for controlling radio link delay in a multi-standard wireless system having a first Radio Equipment Controller (REC) operating with a first radio standard interface and a second REC operating with a second radio standard interface, said interface comprising:
a) a timing source reference for providing a reference timing clock signal;
b) a first timing signal buffer for determining a first time delay between said first REC and a Radio Equipment (RE);
b) a second timing signal buffer for determining a second time delay between said second REC and said RE;
c) a memory for storing received radio signal data from said first and second REC into a memory;
f) a time stamp marker for marking said stored radio signal data in accordance with a time delay calculated by said first and second timing signal buffers; and
g) a multiplexer for multiplexing said marked radio signal data into a single radio signal timed according to said reference timing clock signal for transmission to said RE.

3. An interface as defined in claim 2, wherein said interface is connected to each of said REC via a serial link.

4. An interface as defined in claim 3, wherein said radio signal data is received from said first and second REC along said serial links.

5. An interface as defined in claim 3, wherein each REC is provided with its own serial link to connect to said interface.

6. An interface as defined in claim 2, wherein samples of said radio data are marked by said time stamp marker and then stored into memory.

7. An interface as defined in claim 6, wherein said samples are collected and placed in memory in sequential order.

8. An interface as defined in claim 7, wherein said memory is used to adjust said radio signal samples according to said calculated delay associated with a particular serial link.

9. An interface as defined in claim 8, wherein said marked radio samples are extracted simultaneously.

10. An interface as defined in claim 9, wherein follow-up samples are extracted sequentially.
